(19) United States
(12) Patent Application Publication
(10) Pub. No.: US 2024/0396275 A1
(43) Pub. Date: Nov. 28, 2024

(54) TRIPLE SAW

(71) Applicant: Jayantha S. Mallikarachchi, Tampa, FL (US)

(72) Inventor: Jayantha S. Mallikarachchi, Tampa, FL (US)

(21) Appl. No.: 18/651,659

(22) Filed: Apr. 30, 2024

Related U.S. Application Data
(63) Continuation-in-part of application No. 18/611,081, filed on Mar. 20, 2024.
Application No. 18/611,081 is a continuation-in-part of application No. 18/202,628, filed on May 26, 2023, now Pat. No. 12,023,824.

(51) Int. Cl. H01R 24/70; B23D 47/00; H01R 13/70; H01R 107/00; H02J 7/02

(52) U.S. Cl. CPC H01R 24/70; B23D 47/00; H01R 13/70; H02J 7/02; H01R 2107/00; H02J 2207/20

(57) ABSTRACT

A system and method for a triple saw system that may utilize a removable circular saw in a plurality of different configurations while still allowing the user may use removable circular saw remotely by removing it from the bench whereby the removable circular saw may have a bottom plate for use in connecting to the bench saw or to the miter saw, and able to use alternating current power and battery power.

### CROSS REFERENCE TO RELATED APPLICATIONS

This application is a continuation in part of U.S. patent application Ser. No. 18/611,081, filed Mar. 20, 2024, which is a continuation in part of U.S. patent application Ser. No. 18/202,628, filed May 26, 2023, which are incorporated herein in their entirety.

### FIELD OF DISCLOSURE

The overall field of this invention is for working tools and more particularly a versatile woodworking tool that incorporates various uses such as for a Removable circular saw, Bench saw, or Miter saw.

### BACKGROUND

The disadvantage of using a regular circular saw is that the user would need to drill four holes on the bottom plate and install bolts to the bench in order to attach the circular saw to a bench. They would then need to put grips to keep switches at the ‘ON’ position and always keep the power cable connected to the wall outlet. This is extremely not safe to use and is a safety violation. Thus exists the need for modified circular saw that provides a better design, with a specifically designed power cable.

### SUMMARY

It is an object of the present invention to provide a triple saw configuration including a Removable circular saw, Bench saw, and Miter saw. All of these saws may use a modified removable circular saw that may then be used for three different functions. For consumers, the present invention is less costly, easy to carry, safe, and requires less maintenance for one machine than three if bought separately.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates the wire connections of the removable circular saw of the TRIPLE SAW system.

FIG. 2 illustrates the electrical plug of the removable circular saw.

FIG. 3 illustrates the bottom plate of the removable circular saw.

FIG. 4 illustrates the outlet on the bench of the TRIPLE SAW system.

FIG. 5 illustrates the underside of the bench saw.

FIG. 6 illustrates another view of the bench saw.

FIG. 7 illustrates the bench saw blade guard.

FIG. 8 illustrates the miter saw of the triple saw system.

FIG. 9 illustrates the platform attached to the miter saw.

FIG. 10 illustrates the bench saw, miter saw, and the removable circular saw together in the TRIPLE SAW system.

FIG. 11 illustrates the Battery and AC power connection to the handheld circular saw.

FIG. 12 illustrates the Battery and AC power connection to the bench.

FIG. 13 illustrates the Functionality of the switch on the bench.

### DETAILED DESCRIPTION

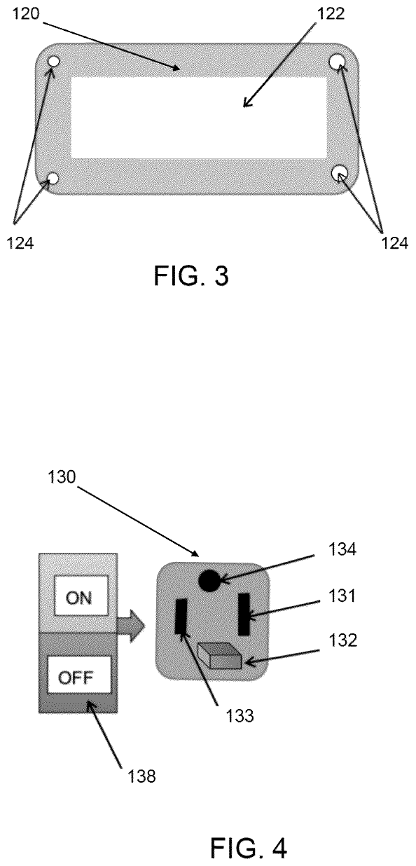

The present invention is directed to a triple saw system 100 with a bench 150 that may utilize an inserted removable circular saw 110 in a plurality of different configurations while still allowing the user to use removable circular saw 110 remotely by removing it from the bench 150. Removable circular saw 110 may have an attached bottom plate 120, as illustrated in FIG. 3 for attaching to underneath of the top plate of the bench 150. Bottom plate 120 may have an opening 122 for the blade of removable circular saw 110 and four holes 124 for fastening removable circular saw 110 to different apparatuses. Front holes 124 may be larger than back holes 124.

Bench 150 is a tool used for cutting various materials. Bench 150 may include a slot 330 to receive the blade of removable circular saw 110. Slot 330 may be positioned on a portion of the bench 150 that is dented with one or more bolts to secure removable circular saw 110.

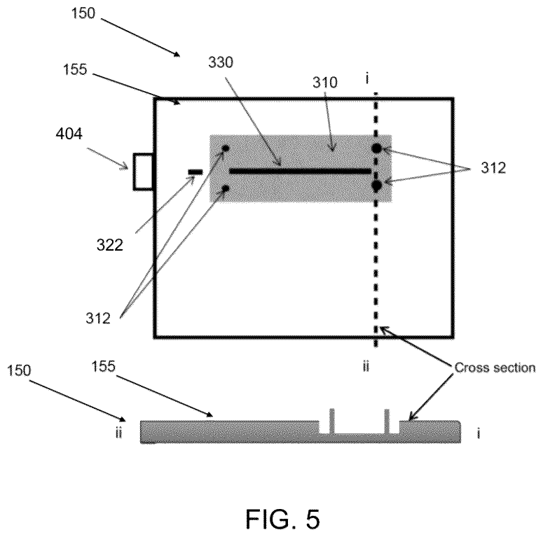

Dented area 310 may have a thickness of ⅛ inch to maximize the blade height. In dented area 310, four bolts 312 may be used hold the removable circular saw 110. The diameter of the two front bolts is larger (⅜ inch), and the diameter of the two rear bolts is smaller (¼ inch), which is to avoid placing removable circular saw 110 on the wrong side, as illustrated in FIG. 5. Bolts 312 may come with butterfly nuts or clamps to attach removable circular saw 110 without a tool. A remainder of the surface area of bench 150 may be ¼ inch to ⅝ inch for stability. As discussed, bottom plate 120 of the circular saw attaches to the underneath of bench 150.

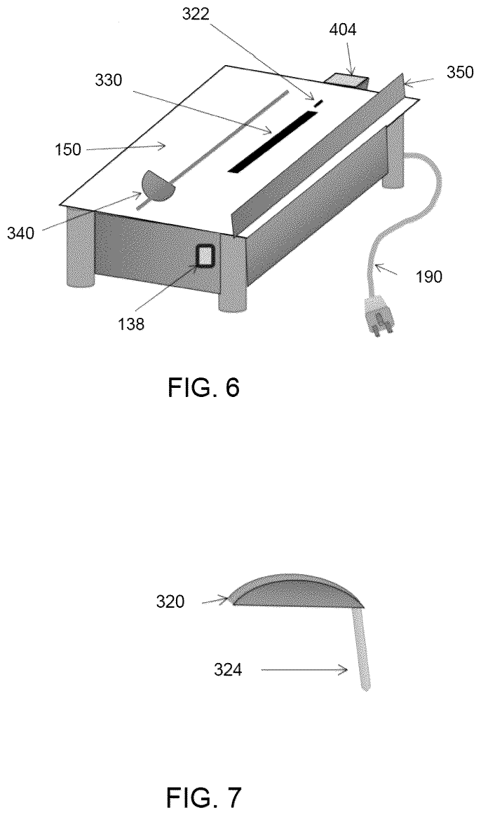

Bench 150 may include a blade guard 320 with a connector 324 positionable in a connection point 322 near slot 330 that covers the saw blade of removable circular saw 110 for safety purposes when cutting, as illustrated in FIG. 7. Bench 150 may include a miter gauge 340 that allows for making angled cuts as illustrated in FIG. 6. Bench 150 may include a fence 350 that is a guide that runs parallel to the blade and helps in making straight cuts along the length of the material. Bench 150 may include switch or button controls such as On/Off switch 138 power to the circular saw motor, allowing the user to start and stop the cutting action.

Bench 150 may attach to the miter saw system 400 which may include a connection point 404 for receiving a connector 402 at an end of bench 150. Miter saw system 400 may be attached to the bench easily and secured with a hand-tighten knob 405. Miter saw system 400 may include a vertical column or arm that may be connected by pivot 408 connected to miter saw extension arm 410.

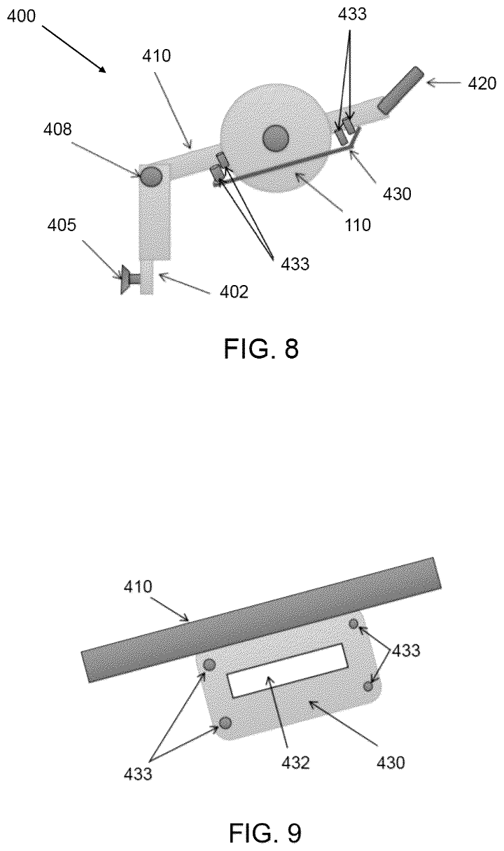

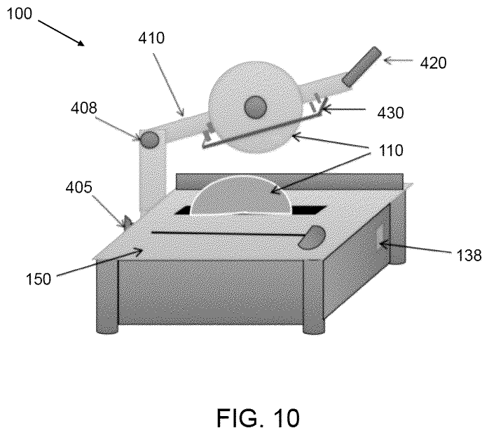

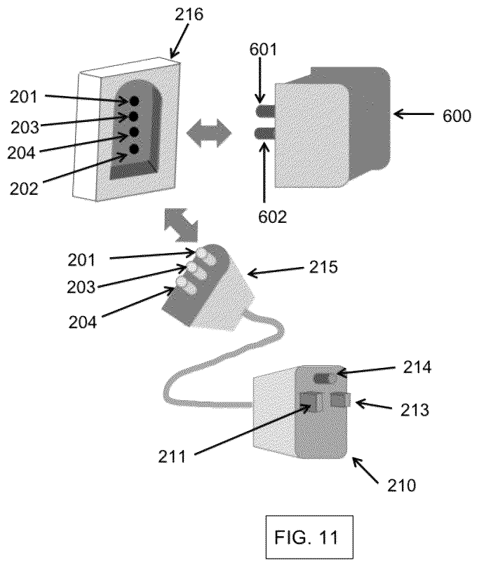

Miter saw extension arm 410 may have a platform 430 along a length of extension arm 410 that is designed for receiving circular saw 110, as illustrated in FIGS. 8 and 9. Platform 430 may have a slot 432 and a series of bolts 433 with back bolts of smaller diameter and front bolts of a larger diameter to connect circular saw 110 to extension arm 410 as illustrated in FIG. 9. Extension arm 410 may be spring loaded whereby the spring assists in raising miter saw extension arm 410 after a cut is made. Extension arm 410 may include a handle 420 or grip at an opposite end of connector 402 that allows the user to lower and control removable circular saw's 110 ascent and descent as illustrated in FIG. 8. When extension arm 410 is down, it aligns with slot 330 on bench 150 for removable circular saw 110 whereby platform 430 rests on top of bench 150 when fully down.

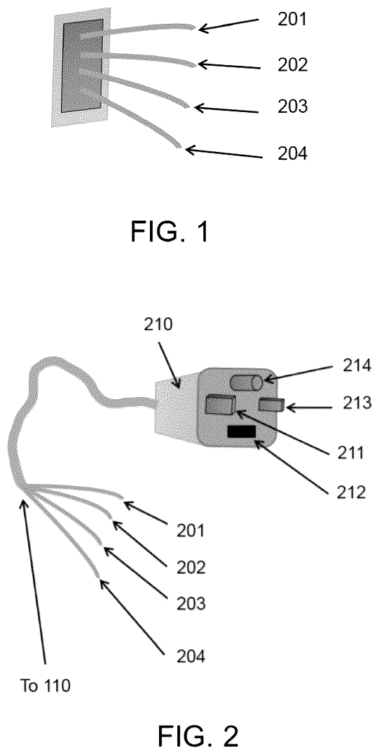

Removable circular saw 110 may be powered by electricity with a power cord, as illustrated in FIG. 2 whereby at one end of the power cable, there is a plug 210 that can be inserted into a power outlet or extension cord. The plug is designed to match the electrical configuration of the outlet, ensuring a secure and safe connection. The power cable may have four wires a live 1 201, live 2 202, neutral 203, and ground 204, as illustrated in FIG. 1 and FIG. 2. Plug 210 at the other end of the power cable may have a ground pin 214, neutral pin 213, live 1 pin 211, and a hole for live 2 pin 212, as illustrated in FIG. 2. In the removable circular saw, the live 1 wire 201 may connect to the on/off switch of the removable circular saw 110. Live 2 wire 202 bypasses the on/off switches of removable circular saw 110 and the switch is capable of transferring power from Live1 to Live 2. Live 1 wire 201 on the power cable connects to the wall outlet live wire, and there is no connection to the live 2 202 from the wall outlet. This design is for removable circular saw operation.

When using the bench saw and miter saw, plug 210 may connect to power outlet 130 on bench 150 as illustrated in FIG. 4. Power outlet 130 may have connections of ground 134, neutral 133, and live 2 132 with no connection to live 1 131. Live 2 pin 132 connects to the live 2 212 on plug 210. On/Off switch 138 connects to live 2 pin 132 and can power on and off to live 212. The bench saw connects to the power from the wall outlet with its cable 190, as illustrated in FIG. 6. This power connection design allows for safe operations of the bench saw and miter saw.

Battery power may also be implemented and easy to use when using the triple saw system is away from a wall electric outlet. Sometimes, the battery may need to be recharged when doing work for a long period. Therefore, when working near a wall outlet, if the user can use AC power, it helps to save the battery power. Therefore, it is easy for a worker to provide both battery power and AC power to the same equipment when it needs to do the job continuously.

The following describes a second embodiment with a modified electrical connection to the Triple Saw, which can use battery and AC power with the same safety configurations.

The handheld circular saw has a connector base 216, FIG. 11, with four receiving connections: Live1 201, Neutral 203, Ground 204, and Live2 202. It is the same as the previously described embodiments. When the battery 600 is attached, it connects positive terminal 601 to Live 1 201 and Negative terminal 602 to Neutral 203. Live1 201 passes through the switches of the handheld circular saw.

Users may connect the AC power from the wall outlet to the same connector base 216 of the Handheld circular saw with the connector1 215. However, it may connect after removing the battery. Therefore, the Handheld saw can use only one power source at a time.

AC power connector1 215 has the same Live1 201, Neutral 203, and Ground 204 connections. Live1 201 goes through the switches of the Handheld saw. The AC power supplier 210 has a step-down transformer and rectifier. The transformer reduces the AC voltage to match the battery voltage, and the rectifier converts the AC to the DC. The AC power supplier 210 has Live1 211, Neutral 213, and Ground 214 connections.

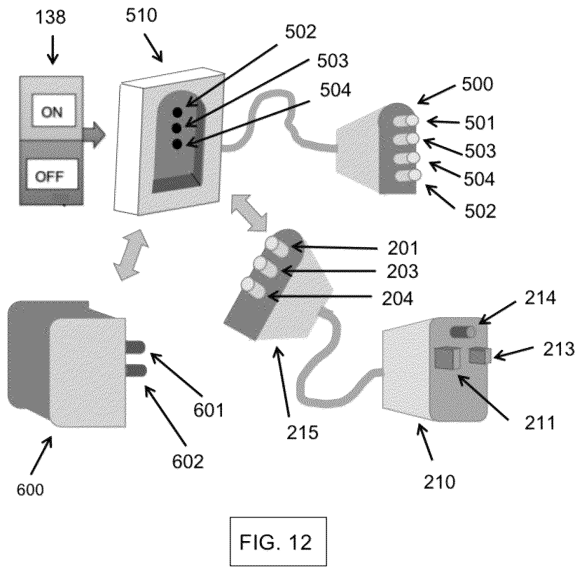

When using the bench saw and Miter saw FIG. 12, the user can use the battery or AC power by connecting to the bench power connector base 510. Nevertheless, it may connect after removing the battery. Therefore, the Bench and Miter saw can use only one power source at a time. When the battery 600 is attached, the positive terminal 601 connects to the Live2 502, and the negative terminal 602 connects to the neutral 503 on the power connecter base 510.

When using AC power connector1 215, Live1 201 connects to Live2 502, Neutral 203 connects to Neutral 503, and Ground 204 connects to Ground 504. When using the Bench and Miter saw, connector2 500 connects to the handheld circular saw. Then Live2 502 connects to 201, but there is no power to connector 501. 503 connects to 203, 504 connects to 204, and 502 connects to 202 on the connector base 216, FIG. 11.

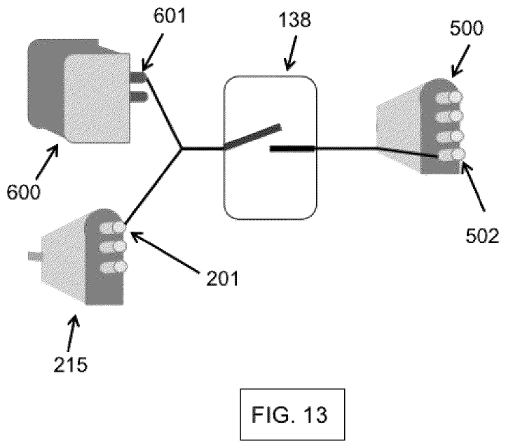

That Live2 502 connects to 202 and bypasses the switches of the Handheld saw. Therefore, the machine can power ON or OFF only through switch 138 on the bench. Connectors 215, 500 and connector bases 216, 510 one side round and the other square to avoid connecting incorrectly. The switch on the bench functions as illustrated in FIG. 13. Battery 600 positive terminal 601 or AC power connector1 215 Live1 201 supplies the power to switch 138. When the switch is ON, it passes the power to Live2 502 on Connector2 500.

1. A circular saw system, comprising: a circular saw having connector bases having four receiving connections including a Live 1 connection, a Live 2 connection, a neutral connection, and a ground connection, wherein the circular saw has an attachable battery that connects a positive terminal to the Live 1 connection and negative terminal to the neutral, wherein the Live 1 connection passes through switches of the circular saw.

2. The circular saw system of claim 1, wherein the connector bases are connectable to a wall outlet or to a battery.

3. The circular saw system of claim 2, further comprising an AC power connector able to connect to the circular saw and to a bench.

4. The circular saw system of claim 3, further comprising an AC power supplier that has a step-down transformer and rectifier.

5. The circular saw system of claim 4, wherein the transformer reduces AC voltage to match battery voltage, and the rectifier converts AC to DC.

6. The circular saw system of claim 5, wherein in a bench saw configuration or miter saw configuration, the circular saw system is powered by the battery or AC power by connecting to a bench connector base.

7. The circular saw system of claim 6, wherein when the battery is attached, the positive terminal connects to a bench power connector Live 2 connection, and a negative terminal connects to a bench power connector neutral on the bench connecter base.

8. The circular saw system of claim 7, wherein when using the AC power connector, the Live 1 connection connects to the bench power connector Live 2 connection, the neutral connection connects to the bench power connector neutral connection, and the ground connection connects to the bench power connector ground connection.

9. The circular saw system of claim 8, wherein in the Bench saw configuration or the Miter saw configuration a connector that connects to the circular saw, wherein a bench power connector Live 1 connection connects to the Live 1 connection, wherein there is no power to the bench power connector Live 1 connection.

10. The circular saw system of claim 9, wherein in the Bench saw configuration or the Miter saw configuration, the neutral connection connects to the bench power connector neutral connection, and the ground connection connects to the bench power connector ground connection, and the Live 2 connection connects to the bench power connector Live 2 connection.

11. The circular saw system of claim 10, wherein the circular saw system can power ON or OFF only through a switch on a bench and the switch transfers power from Live1 to Live 2.
